(19) United States
(12) Patent Application Publication
(10) Pub. No.: US 2003/0111583 A1
(43) Pub. Date: Jun. 19, 2003

(54) Support for display cards depicting religious images

(76) Inventor: Santarpia Gaetano, Milano (IT)

Correspondence Address: Robert D. Traver, Esq., SHERIDAN ROSS P.C., Suite 1200, 1560 Broadway, Denver, CO, 80202-5141, US

(21) Appl. No.: 10/318,545

(22) Filed: Dec. 13, 2002

(30) Foreign Application Priority Data
Dec. 13, 2001 (IT) MI2001U 000649

(51) Int. Cl. B60R 1/02; A47G 29/00

(52) U.S. Cl. 248/473; 248/346.03

(57) ABSTRACT

A support (1; 101), for display cards (30) depicting religious images, comprises a flat base (2; 102) suitable for being rested on a horizontal plane, a body (14; 114) which rises up from the flat base, and a slot (7; 107), formed in the body along a cutting plane substantially at right angles to the base (2; 102), said slot (7; 107) having such a width as to be able to hold the lower end part of a display card (30) depicting religious images, so as to support it in a position substantially at right angles to the horizontal plane whereon the support (1; 101) is positioned.

### DESCRIPTION

The present invention relates to a support for display cards, in particular for display cards in paper, plastic-coated paper, plastic and the like, which depict religious images and the like.

As is known, various types of display cards are widely available on the market, depicting religious images or in any case those of religious content, such as Madonnas, saints etc. These display cards generally have a substantially rectangular shape, are covered in transparent plastic and depict on one side the religious image and on the opposite side a prayer, generally related to the image.

Display cards are also known which, in addition to a religious image, have a medallion or coin integrated in the card. Such a display card is described in the Italian patent application MI2001A189 in the name of the same Applicant.

The object of the present invention is to provide a support for display cards of religious images which is economical and easy to produce.

Another object of the present invention is to provide such a support for display cards which is compact and practical for the user.

Yet another object of the present invention is to provide such a support for display cards which is versatile and suitable for holding different types of display cards of various shapes and sizes.

These objects are achieved in accordance with the invention with the features listed in the annexed independent claim 1.

Advantageous embodiments of the invention are disclosed by the dependent claims.

The support for display cards depicting religious images, according to the invention, comprises a flat base designed to be rested on a horizontal support plane, a body which rises up from the flat base, and a slot formed in the body, along a cutting plane substantially at right angles to the base.

The slot has such a width as to be able to hold the lower end part of a display card depicting religious images, in order to support it in a position substantially at right angles to the horizontal support plane whereon the support is positioned.

In particular, in the slot, restraining teeth are provided, having such a configuration as to allow display cards of different thickness to be blocked in position.

The advantages of the support according to the invention are clear. In fact this support allows display cards of various shapes and sizes to be maintained in an erect position.

Further features of the invention will be made clearer by the following detailed description, referring to purely exemplary and therefore non-limiting embodiments thereof, illustrated in the accompanying drawings, in which:

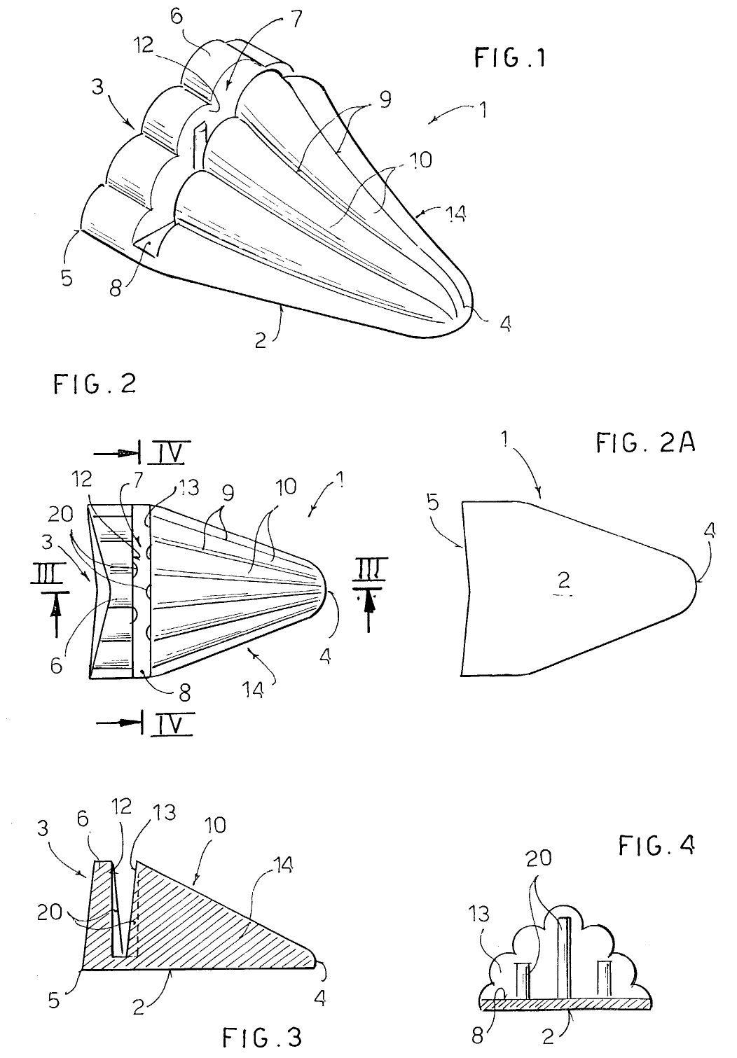

FIG. 1 is a perspective view of a support for display cards of religious images according to a first embodiment of the invention;

FIG. 2 is a top plan view of the support of FIG. 1;

FIG. 2A is a bottom plan view of the support of FIG. 1;

FIG. 3 is a longitudinal sectional view taken along the sectional plane III-III of FIG. 2;

FIG. 4 is a cross sectional view taken long the sectional plane IV-IV of FIG. 2;

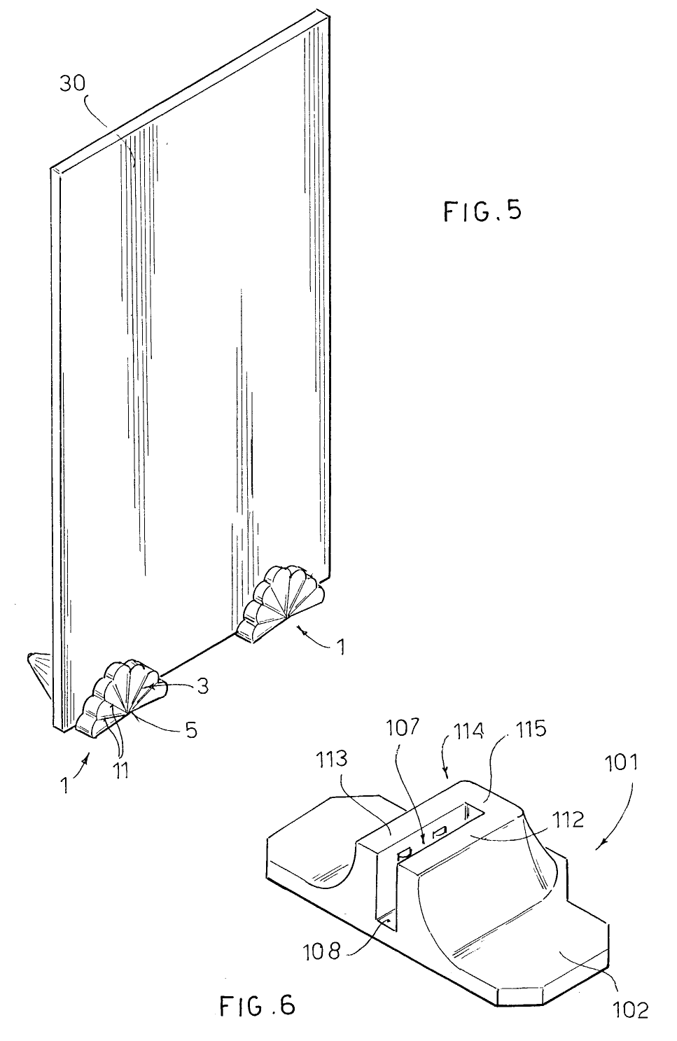

FIG. 5 is a perspective view illustrating a display card supported by two supports according to the first embodiment of the invention;

FIG. 6 is a perspective view illustrating a second embodiment of the invention;

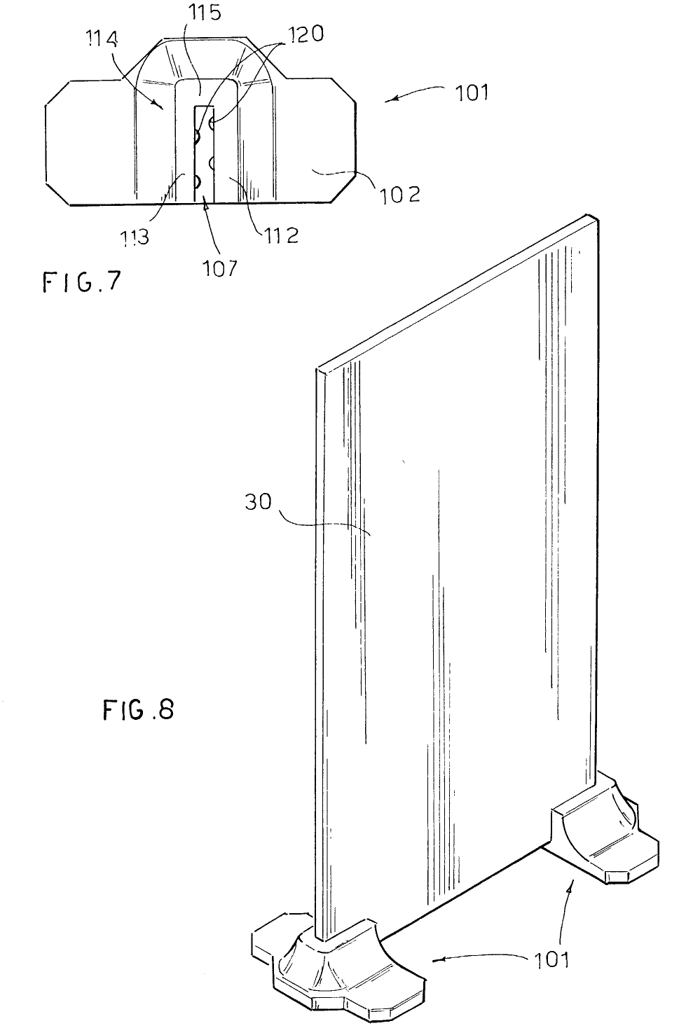

FIG. 7 is a top plan view of the support of FIG. 6;

FIG. 8 is a perspective view illustrating a display card supported by two supports according to the second embodiment of the invention.

With the aid of the drawings the support for display cards according to the invention is described.

Referring for the time being to FIGS. 1-5, a support is described, denoted overall by reference numeral 1, according to a first embodiment of the invention.

As shown in FIG. 2A, the support 1 has a flat base 2 with a substantially isosceles triangle shape, suitable for being rested on a plane. The shortest side of the base 2, denoted by reference numeral 5, forms the front end of the support 1. The tip of the base 2 opposite the shortest side 5 of the base is denoted by reference numeral 4. The tip 4 is rounded and forms the rear end of the support 1.

From the base 2 a body 14 rises up, having substantially the configuration of a pyramid cut along a plane passing through its axis.

The body 14 has a front surface 3 which rises up from the shortest side 5 of the base, along a plane substantially at right angles to the base 2. The front surface 3 also has substantially the shape of an isosceles triangle. The tip of the front surface 3 opposite the shortest side 5 of the base is denoted by reference numeral 6 and forms the highest point of the support 1.

Immediately behind the front surface 3, in the body 14, a transverse slot 7 is provided, cut along a plane substantially at right angles to the base 2. The transverse slot 7 has the shape of a substantially triangular cavity, is open above and at the sides and ends in a lower counter surface 8. The width of the slot 7 is sufficient for allowing insertion of a display card, even of considerable thickness.

The slot 7 is defined therefore between a vertical front wall 12 and a vertical rear wall 13 of the body 14 of the support. The body 14 of the support has a tapered configuration converging towards the rear end tip 4. On the external surface of the body 14 of the support longitudinal grooves 9 are provided which, from the front surface 3, converge towards the rear end tip 4. Between the longitudinal grooves 9 longitudinal projections 10 are defined, having a substantially rounded shape.

As shown in FIG. 5, in the front surface 3 radial grooves 11 are provided which, starting from a median point of the shortest side 5 of the base 2, branch out towards the exterior of the front surface 3.

As shown in FIG. 2, on the front wall 12 and on the rear wall 13 of the body 14 restraining teeth 20 are provided. The restraining teeth 20 are projections, substantially at right angles to the base 2, which face each other in the slot 7.

The restraining teeth 20 are preferably arranged staggered on the front wall 12 and on the rear wall 13 of the body 14. Moreover the restraining teeth 20 have a tapered configuration with thickness increasing from the top downwards.

The restraining teeth 20 form a narrowing of the slot 7 and this narrowing becomes increasingly narrower moving from the top downwards. In this way in the slot 7 display cards of different thickness can be inserted. In fact by pushing the display card downwards in the slot 7, the lower end of the display card is forced between the restraining teeth 20, until the card is blocked in position, with the restraining teeth 20 which firmly grip its lower part.

In this way cards of different thickness can be blocked firmly in position. Clearly the cards of greater thickness will have their lower end distanced from the abutment surface 8 of the slot 7 and the cards of smaller thickness will have their lower end close to the abutment surface 8 of the slot 7.

As shown in FIG. 5, a display card 30 is supported in a substantially vertical position, or slightly tilted backwards, in relation to the horizontal plane, by means of two supports 1, according to the first embodiment of the invention.

Clearly the display card 30 can be supported by a single support 1 or by more than two supports 1.

With the aid of FIGS. 6-8 a support is described, according to a second embodiment of the invention, denoted overall by reference numeral 101. Referring to FIG. 6. the support 101 has a flat base 102, substantially rectangular, generating a surface for resting of the support. In a median position, from the base 102 a body 114 rises up, having a substantially parallelepiped shape. In the body 114 a transverse slot 117 is formed with a substantially rectangular shape. The slot 117 is defined by a front wall 112, a rear wall 113 parallel to the front wall, a side part 115 which joins the front wall 112 to the rear wall 113 and a lower wall 108 defined by the base 102.

Therefore the transverse slot 117 is open above and on one side. In the surfaces of the front wall 112 and rear wall 113 turned towards the slot 107 restraining teeth 120 are provided, substantially identical to the restraining teeth 20 of the first embodiment and therefore their detailed description is omitted.

As shown in FIG. 8, in this case two supports 101 according to the second embodiment are placed in the comers of the lower part of the display card 30 to support it. The supports 1 and 101 can be made in one single part in a metal material by casting in a mould. Alternatively they can also be made by injection moulding of a plastic material.

The supports 1 and 101 can be made by gluing onto a card in paper or plastic. This packaging card can bear a religious image on the side which holds the support and the instructions for use on the side opposite to that which holds the support.

A number of variations and modifications of detail within the reach of person skilled in the art can be made to the present embodiments of the invention, and in any case coming within the scope of the invention as set forth in the appended claims.

1. A support (1; 101) for display cards (30) depicting religious images, characterised in that it comprises:
a flat base (2; 102) suitable for being rested on a horizontal plane,
a body (14; 114) which rises up from said flat base,
a slot (7, 107) formed in said body along a cutting plane substantially at right angles to said base (2; 102), said slot (7; 107) having such a width as to be able to hold the lower end part of a display card (30) depicting religious images, to support it in a position substantially at right angles to the horizontal plane whereon the support (1; 101) is positioned.

2. A support according to claim 1, characterised in that said slot (7; 107) is defined by a front wall (12; 112) substantially at right angles to said base (2; 102) and by a rear wall (13; 113) substantially parallel to said base (2; 102) and by a rear wall (13; 113) substantially parallel to said front wall, and in that in said slot restraining teeth (20; 120) are provided, integral with said rear wall and/or said front wall, suitable for holding the lower end part of the display card (30).

3. A support according to claim 2, characterised in that said restraining teeth (20; 120) are arranged in staggered positions on said rear wall (13; 113) and said front wall (12; 112):

4. Support according to claim 2 or 3, characterised in that said restraining teeth (20; 120) comprise projections, arranged parallel one to the other and at right angles to the base (2; 102), on said rear wall (13; 113) and on said front wall (12; 112).

5. A support according to claim 4, characterised in that said restraining teeth (20; 120) are tapered from the top downwards with increasing thickness, so as to be able to grip display cards of different thickness.

6. A support (1) according to any one of the previous claims, characterised in that said base (2) has a substantially triangular shape and said body (14) has a shape substantially of a pyramid truncated along an axial plane.

7. A support according to claim 6, characterised in that said rear wall (13) and said front wall (12) which define said slot (7) have a substantially triangular shape and said slot is open above and at the sides.

8. A support according to claim 6 or 7, characterised in that on the external surface of said body (14) a plurality of longitudinal grooves (9) are provided which define a plurality of longitudinal projections (10).

9. A support according to any one of claims 6 to 8, characterised in that on the front surface (3) turned towards the outside of said front wall (12) a plurality of radial grooves (11) are provided.

10. A support (101) according to any one of claims 1 to 5, characterised in that said base (102) is substantially in the shape of a rectangular plate and said body (114) is substantially in the shape of a parallelepiped which rises up from the median part of said base.

11. A support according to claim 10, characterised in that said slot (107) is substantially rectangular and is open above and on one single side to hold a corner of a display card (30).

12. A support (1; 101) according to any one of the previous claims, characterised in that it is made in a metal material by casting.

13. A support (1; 101) according to any one of the previous claims, characterised in that it is packaged as a package item wherein it is removably attached to a card bearing a religious image.
